(19) United States
(12) Patent Application Publication
(10) Pub. No.: US 2007/0125961 A1
(43) Pub. Date: Jun. 7, 2007

(54) MICROMECHANICAL SYSTEM

(76) Inventor: Michel Despont, General-Werdmuellerstrasse (CH)

Correspondence Address: Ido Tuchman, 82-70 Beverly Road, Kew Gardens, NY, 11415, US

(21) Appl. No.: 11/560,830

(22) Filed: Nov. 16, 2006

(30) Foreign Application Priority Data
Nov. 17, 2005 (EP) 0511078.5

(51) Int. Cl. G21G 5/00

(52) U.S. Cl. 250/492.1

(57) ABSTRACT

A micromechanical system including a micromechanical structure and a shadow mask device. The micromechanical structure and the shadow mask device are produced from a single wafer. The micromechanical structure includes a covering surface to be acted upon in a covering area. The covering surface is produced in the course of covering surface processing steps. The shadow mask device is provided for shading part of the micromechanical structure from a deposition or treatment beam. It has at least one geometry, which affects a shading area in respect to the covering surface and which is produced in the course of geometry processing steps. The covering surface and geometry processing steps are applied from one side of the wafer.

### CROSS-REFERENCE TO RELATED APPLICATIONS

This application claims priority under 35 U.S.C. § 119 to European Patent Application No. 0511078.5 filed Nov. 17, 2005, the entire text of which is specifically incorporated by reference herein.

### BACKGROUND OF THE INVENTION

The field of the present invention embraces techniques that use nanometer-sized tips for imaging and investigating the structure of materials down to the atomic scale. Such techniques include scanning tunneling microscopy (STM) and atomic force microscopy (AFM), as disclosed in U.S. Pat. No. 4,343,993 and European Patent Publication On. 0 223 918 B1 and are generally referred to as scanning probe microscopies (SPM).

Scanning probe microscopies (SPM) have become an important tool for the characterization of a large variety of surfaces and for the measurement of forces of different physical origin. As can be appreciated, the role of probes that are used for this purpose is crucial for the SPMs. Intensive effort has been made to develop various probes to meet the requirements of different SPMs. A probe consists basically of four parts, a tip, a cantilever beam, which is basically a spring system, a chip body anchoring the cantilever and allowing manual manipulation and in many cases a reflecting layer on a surface of the cantilever, for example, the surface disposed opposite to that on which the tip is attached, so as to facilitate better reflection of a laser beam used in a detection system.

In the paper, “Miniaturized Single-Crystal Silicon Cantilevers for Scanning Force Microscopy” by Yang et al., Applied Physics Letters 86, 134101, 2005, published on-line Mar. 21, 2005, such a probe is disclosed. It is further disclosed that the mechanical properties of the cantilever sets limits to both the force sensitivity and the measurement speed of an SPM. It proposes to increase the resonance frequency of the respective cantilever. In this respect, it proposes to reduce the dimensions of the cantilever. It further discloses that, at the point where the cantilever is attached, the chip should have a width comparable to the cantilever length. In order to detect the deflection of a small cantilever using optical methods, a small spot is required, thus a large opening angle above the cantilever is necessary. For that purpose, a triangular shape of the support chip near the cantilever fixation is proposed, which allows sufficient clearance for the cantilever-sample approach. The optical opening angle is obtained by a recess step during the manufacturing process, with the maximum thickness predefined by the cantilever length and the required opening angle. In order to obtain a precise length of the cantilever, the cantilever length is determined by front-side etching only, even for cantilevers without a backbone, resulting in an excellent control of the anchoring point.

U.S. Pat. No. 6,080,513 discloses a method for modification of a surface of a substrate, which is to be exposed to a medium directed towards the surface. A mask is used, which has at least one opening through which the medium is allowed to reach the surface. The opening is located in a protrusion of the mask which is directed versus the surface. The surface is preferably part of a membrane. Due to the fact that the opening comes to lie nearer to the membrane than it would if the protrusion were absent, the pattern created by the material has more well-defined contours than patterns created according to other previously-proposed methods.

Based on the developments in scanning tunneling microscopy and atomic force microscopy, new storage concepts have been introduced over the past few years that profit from these technologies. Probes having a tip with a nanoscale-sized apex have been introduced for modifying the topography and for scanning an appropriate storage medium. Data are written as sequences of bits represented by topological marks, such as indentation marks and non-indentation marks. The tips comprise apexes with nanometer-sized diameter, for example, in the range of 20 to 40 nm. Hence, these data storage concepts promise ultra-high storage area density.

A data storage device based on the AFM principle is disclosed in “The millipede—more than 1,000 tips for future AFM data storage” by P. Vettiger et al., IBM Journal Research Development, Vol. 44, No. 3, March 2000. The storage device has a read and write function based on a mechanical x-, y-scanning of a storage medium with an array of probes each having a tip. The probes operate in parallel with each probe scanning, during operation, an associated field of the storage medium. In this way, high data rates may be achieved. The storage medium comprises a polymethylmethacrylate (PMMA) layer. The nanometre-sized tips are moved across the surface of the polymer layer in a contact mode. The contact mode is achieved by applying forces to the probes so that the tips of the probes can touch the surface of the storage medium. For this purpose, the probes comprise cantilevers, which carry the tips on their end sections. Bits are represented by indentation marks or non-indentation marks in the polymer layer. The cantilevers respond to these topographic changes in the surface while they are moved across it.

Indentation marks are formed on the polymer surface by thermomechanical recording. This is achieved by heating a respective probe with a current or voltage pulse during the contact mode in a way that the polymer layer is softened locally where the tip touches the polymer layer. The result is an indentation, for example, having a nanoscale diameter, being formed on the layer.

Reading is also accomplished by a thermomechanical concept. The heater cantilever is supplied with an amount of electrical energy, which causes the probe to heat up to a temperature that is not enough to soften the polymer layer as is necessary for writing. The thermal sensing is based on the fact that the thermal conductance between the probe and the storage medium, especially a substrate on the storage medium, changes when the probe is moving in an indentation as the heat transport is in this case more efficient. As a consequence of this, the temperature of the cantilever decreases and hence, also its electrical resistance changes. This change of electrical resistance is then measured and serves as the measuring signal.

In STM, a nanometre-sized tip is scanned in close proximity to a surface. The voltage applied therebetween gives rise to a tunnel current that depends on the tip-surface separation. From a data-storage point of view, such a technique may be used to image or sense topographic changes on a flat medium that represent a stored information in logical “0s” and “1s”. In order to achieve a reasonably stable current, the tip-sample separation must be maintained extremely small and fairly constant. In STM, the surface to be scanned needs to be an electrically conductive material.

Accordingly, it is desirable to provide a micromechanical system and a manufacturing method therefore, which enables a precisely localized actuation in a given area of the micromechanical system. It is also desirable to provide a method for manufacturing a micromechanical structure corresponding to the aforementioned micromechanical system.

### BRIEF SUMMARY OF THE INVENTION

According to an embodiment of a first aspect of the present invention, there is provided a micromechanical system comprising: a micromechanical structure and a shadow mask device; the micromechanical structure and the shadow mask device being produced from a single wafer; the micromechanical structure comprising a covering surface to be acted upon in a covering area; and the shadow mask device being provided for shading part of the micromechanical structure from a deposition or treatment beam and having at least one geometry, which affects a shading area in respect to the covering surface and which is produced in the course of geometry processing steps being applied from a same side of the wafer as covering surface processing steps for creating the covering surface. In this embodiment, the deposition beam may be, by way of example, due to metal evaporation or epitaxial processes. The treatment beam may be due to implantation or doping, e-beam, ion-beam, or a photon exposure. Since the geometry processing and covering surface processing steps are applied from the same side of the wafer, double-side alignment is not used in order to form the at least one geometry. This has the effect that a more precise control of the geometry may be achieved in respect to the micromechanical structure. This then enables a more precise deposition of material or treatment of the covering surface in the covering area. In particular, a reflecting layer comparable to, or smaller than, the covering surface may be formed, by way of example, when applying a respective evaporation beam at a suitably chosen angle to the covering surface. It is preferred that the shadow mask device is removable from the micromechanical system without affecting, especially destroying, the micromechanical structure. In addition to that, the shadow mask device may be positioned in proximity to the micromechanical structure. This may enhance the precision of acting upon the covering area, in particular, more precision of acting upon the covering area may be achieved from a further side of the wafer other than the side from which the geometry and covering surface processing steps are applied. In this way, the treatment or deposition beam may be applied from the further side of the wafer. The geometry processing steps and the covering surface processing steps may be identical or partly common or distinct from each other.

According to a preferred embodiment of the micromechanical system, the wafer comprises a buried oxide layer and the micromechanical structure is formed on one side of the buried oxide layer. The shadow mask device is formed on the other side of the buried oxide layer. The buried oxide layer is removed in the area of the covering surface and the shadow mask device. The thickness in a vertical direction of the buried oxide may be more precisely given. In this way, a more precise vertical distance between the mechanical structure, in particular its covering surface, and the shadow mask device may be obtained.

According to a further preferred embodiment of the micromechanical system, the shadow mask device comprises a shadow mask beam, which is movable between an initial position and a shading position. In this way, a possible collision between the shadow mask beam and the micromechanical structure may be prevented and on the other hand a more precise formation of the actuation upon the covering surface by the deposition or treatment beam may be achieved.

According to a further preferred embodiment of the micromechanical system, the shadow mask device comprises a micromechanical actuator for moving the shadow mask beam. This enables a more precise movement of the shadow mask beam due to an integrated structure of the micromechanical actuator and the shadow mask beam. Furthermore, no external actuator is then used. The actuator may, by way of example, be an electrostatic or thermal actuator, for example, of a comb or a bimorph or a thermal beam or expansion type.

According to a further preferred embodiment of the micromechanical system, the shadow mask beam is part of a lever. In this way, a force-way relationship may be appropriately set.

According to a further preferred embodiment of the micromechanical system, the shadow mask device comprises a locking device with a locking element associated to the shadow mask beam and a locking beam, being formed and arranged such that, in a locking state, the locking beam is coupled to the locking element in a way so as to fix the shadow mask beam in its shading position. This has the advantage that the actuator acting on the shadow mask beam does not need to be precise. It just needs to push the locking beam to the locking state. In addition to that, the actuator may then be removed while the shadow mask beam may rest in its shading position.

According to a further preferred embodiment of the micromechanical system, the shadow mask beam is in the form of a bistable latch. This has the advantage that an actuator acting on the shadow mask beam to move it from, for example, its initial position to the shading position or vice-versa, does not need to be precise. In addition to that, no separate fixation is used.

According to a further preferred embodiment of the micromechanical system, the shadow mask beam has a coplanar surface to the covering surface, which forms a vertical end of the shadow mask beam facing towards the deposition or treatment beam and the shadow mask beam being formed laterally to the micromechanical structure. This has the advantage that no vertical movement prior to exposing the micromechanical structure to the deposition or treatment beam is used. It enables to have a simpler actuation.

According to an embodiment of a second aspect of the present invention, there is provided a method for manufacturing a micromechanical system comprising a micromechanical structure and a shadow mask device. The shadow mask device is provided for shading part of the micromechanical structure from a deposition or treatment beam. The method comprises the steps of: producing the micromechanical structure and the shadow mask device from a single wafer; creating, in the course of covering surface processing steps, a covering surface in the micromechanical structure, to be acted upon in a covering area; creating at least one geometry in the shadow mask device, which affects a shading area in respect to the covering surface, in the course of geometry processing steps being applied from a same side of the wafer as the covering surface processing steps. The advantages of an embodiment of the second aspect of the invention and its corresponding preferred embodiments correspond to an embodiment of the first aspect of the present invention.

According to an embodiment of a third aspect of the present invention, there is provided a method for manufacturing a micromechanical structure from a micromechanical system. The micromechanical system comprises the micromechanical structure and a shadow mask device. The shadow mask device is provided for shading part of the micromechanical structure from a deposition or treatment beam. The method comprises the steps of: producing the micromechanical structure and the shadow mask device from a single wafer; creating, in the course of covering surface processing steps, a covering surface in the micromechanical structure to be acted upon in a covering area; creating at least one geometry in the shadow mask device, which affects a shading area in respect to the covering surface, in the course of geometry processing steps being applied from a same side of the wafer as the covering surface processing steps. It further comprises the step of applying the deposition or treatment beam. The advantages of an embodiment of the third aspect of the invention and its preferred embodiments correspond to an embodiment of the first aspect of the invention. It is preferred that the micromechanical structure is separated from the shadow mask device after applying the deposition or treatment beam.

According to a preferred embodiment of the third aspect of the invention, prior to applying the deposition or treatment beam, a shadow mask beam of the shadow mask device is moved, which affects the shading area in respect to the covering surface in a given shading position. This enables design freedom for the shadow mask beam and may prevent a collision between the shadow mask beam and the micromechanical system.

According to a further preferred embodiment of the method for manufacturing the micromechanical structure, after applying the deposition or treatment beam, the shadow mask beam is moved away from the given shading position. Then, the micromechanical structure is separated from a frame structure holding the micromechanical structure and the shadow mask device. This enables a safe release of the micromechanical structure and, in this way results in a higher production yield.

### BRIEF DESCRIPTION OF THE SEVERAL VIEWS OF THE DRAWINGS

FIG. 1 is a side view of a probe contemplated by the present invention.

FIG. 2A is a side view of a first embodiment of a micromechanical system.

FIG. 2B is a top view of the system of FIG. 1 in an initial position.

FIG. 2C is a top view of the system of FIG. 1 in a shading position.

FIG. 3A is a top view of the first embodiment in the initial position and in the shading position.

FIG. 3B shows a second embodiment of the micromechanical system in the initial position and in the shading position.

FIG. 3C shows a third embodiment of the micromechanical system in its initial position and in its shading position.

FIG. 3D shows a fourth embodiment of the micromechanical system in its initial and its shading position.

FIG. 4A shows a fifth embodiment of the micromechanical system in its initial position.

FIG. 4B shows the fifth embodiment of the micromechanical system in its shading position and when the micromechanical actuator is exposed to elevated temperatures.

FIG. 4C shows the fifth embodiment of the micromechanical system in its shading position and when the micromechanical actuator is no longer exposed to elevated temperatures.

FIG. 5A shows a sixth embodiment of the micromechanical system in its initial position.

FIG. 5B shows the sixth embodiment of the micromechanical system in its shading position.

### DETAILED DESCRIPTION OF THE INVENTION

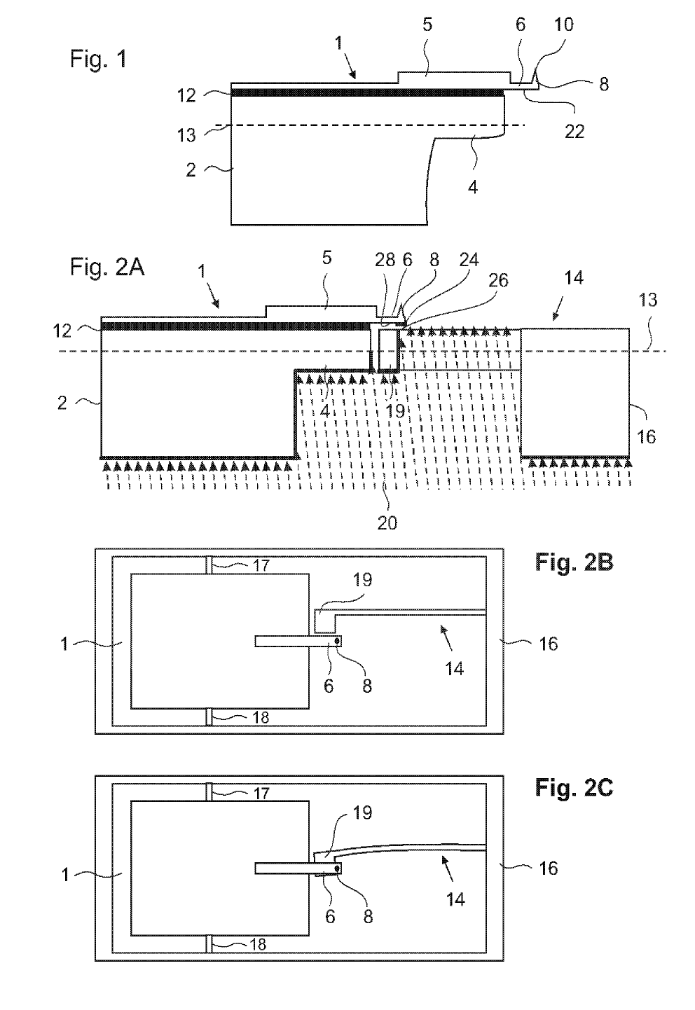

FIG. 1 shows a micromechanical structure 1, which is preferably embodied as a probe being adopted to be used in scanning probe microscopy (SPM). The micromechanical structure 1 may, however, also be another kind of micromechanical structure 1, for example, an optical mirror, a bridge-like element, a beam-like element, or a membrane-type element, which are all preferably anchored. The micromechanical structure may, for example, also form a bimorph actuator or a strain sensor.

The micromechanical structure 1 comprises a support chip 2 having an anchoring part 4. The support chip may have a vertical extension of, for example, 600 μm. The anchoring part may, for example, have a vertical extension of around 200 μm. The micromechanical structure 1 further comprises a backbone 5 and a cantilever 6. The cantilever 6 serves as a spring structure for the probe. In addition to that, a tip 8 is provided with a nanoscale apex 10. The anchoring part 4 is provided for anchoring the cantilever 6, which, in this case, is done via backbone 5. The cantilever 6 typically has vertical dimensions of, for example, less than 5 μm. In addition to that, the cantilever 6 typically has lateral dimensions, for example, of 10 μm or less. A buried oxide layer 12 of defined vertical dimensions, for example also 1 μm, is provided. The micromechanical structure 1 is manufactured from a single wafer. Preferably, processing steps for manufacturing the micromechanical structure 1 are as described in Yang et al., Applied Physical Letters 86, 134101 (2005), which discloses, by way of a process flow chart, the various processing steps, and which is incorporated by reference herein in this respect.

Referring to FIGS. 2A to 2C, a micromechanical system according to a first embodiment of the present invention comprises the micromechanical structure 1, a shadow mask device 14 and a frame structure 16. The micromechanical system is manufactured from a single wafer. All the structures of the micromechanical system in a vertical direction above line 13 in the view plane of FIG. 2A are manufactured from a front side of the wafer, that is, with processing steps applied from the front side of the wafer. The structures below line 13 in the vertical direction are manufactured from the backside of the wafer.

The micromechanical system further comprises holding arms 17, 18, fixing the micromechanical structure 1 to the frame structure 16.

The shadow mask device 14 comprises a shadow mask beam, being shown in FIG. 2B in its initial position and in FIG. 2C in its shading position. The shadow mask beam 19 is formed such that, in its shading position, it shades a part of the micromechanical structure from a deposition or treatment beam 20. It has at least one geometry that is preferably an edge 26, which affects a shading area 28 in respect to a covering surface 22. The at least one geometry may also be referred to as relevant geometry. The deposition or treatment beam 20 may be of the type used for metal evaporation or epitaxial processes, or for treatment the covering surface 22 by implantation or doping, e-beam, ion-beam or photon exposure.

In a preferred embodiment, the deposition or treatment beam 20 is the evaporation beam used for depositing a reflecting layer, such as a layer of aluminum. By suitably choosing the angle of the deposition or treatment beam 20, it only adds on the covering surface 22 in a covering area 24 and may, in the preferred case of an evaporation beam, form a pad of reflecting material, such as aluminum, in the covering area 24.

A more precise location of the relevant geometry, in this case, in particular the edge 26 of the shadow mask beam 19, is obtained by producing at least the edge 26 of the shadow mask beam 19 in the course of geometry processing steps and by creating the covering surface 22 in the course of covering surface processing steps. The geometry and the covering surface processing steps may be identical or partly common or distinct from each other. The geometry and the covering surface processing steps are all applied from one side of the wafer, preferably from the front side. They may however also all be applied from the backside of the wafer. In this respect, it is important to note that e.g. additional processing steps may be used for forming the shadow mask device 14, in particular the shadow mask beam 19 and further in particular the edge 26 compared to the micromechanical structure 1 and here in particular the covering surface 22. The geometry and the covering surface processing steps may be of a type disclosed in Yang et al., Applied Physical Letters 86, 134101 (2005), or some other kind known to a person skilled in the art as being suitable for that purpose. The geometry processing steps affect the relevant geometry. The covering surface processing steps affect geometrical properties of the covering surface.

The covering surface and geometry processing steps may comprise lithography and etching processes, for example. They may comprise, for example, growing silicon dioxide (SiO₂) layers thermally, patterning the silicon dioxide layer with reactive ion etching (RIE) for defining a mask. They may comprise isotropic reactive ion etching and/or wet etching. They may also comprise deep reactive ion etching (DRIE), from a backside and depositing an aluminum layer from the backside, serving as an etch stop for a front side reactive ion etching. The reactive ion etching from the front side may be of anisotropic or isotropic type. It may also comprise underetching processes.

Preferably, the vertical distance between the edge 26 of the shadow mask beam 19 and the covering surface 22 may be more precisely defined by the thickness of the buried oxide layer. It is in this context preferred that the micromechanical structure 1 is formed on one side of the buried oxide layer 12 and that the shadow mask device 14 is formed on the other side of the buried oxide layer 12 and that the buried oxide layer 12 is removed in the area of the covering surface 22 and the shadow mask device 14. The shadow mask beam 19 may then only need to be laterally moved for moving it from its initial position (FIG. 2B) to its shading position (FIG. 2C), in which the deposition or treatment beam 20 may be applied to the micromechanical system.

By manufacturing the shadow mask device 14 and the micromechanical structure 1 from the same wafer, they can be vertically positioned in close proximity, which enhances the possibility for forming the covering area 24 with more precision. In this way, it may, for example, be possible to form the covering area 24 with lateral dimensions of 4 μm by 4 μm.

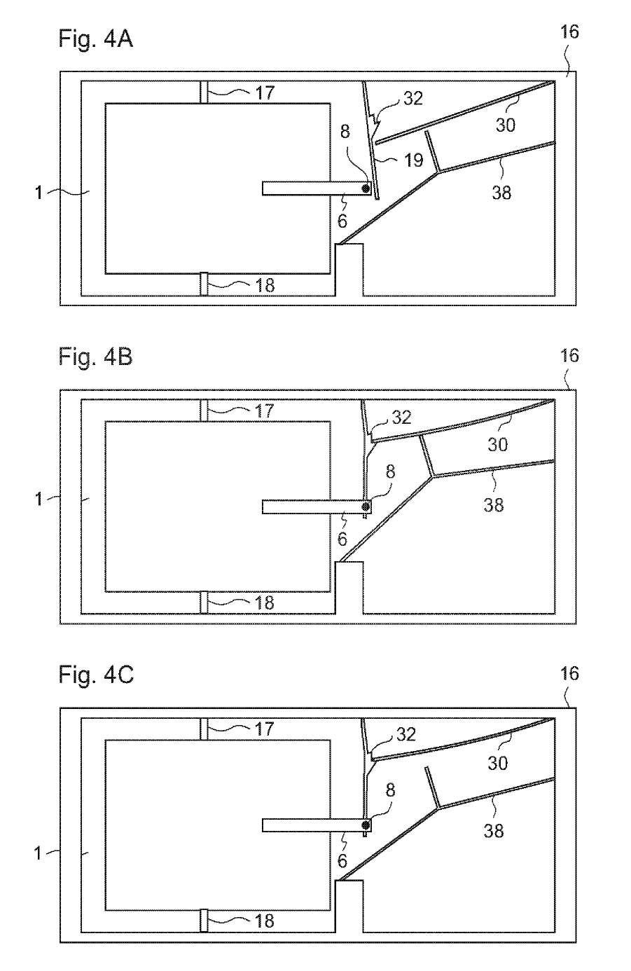

The processing steps from the front side, in particular, provide a lateral position accuracy of the shadow mask beam 19 relative to the micromechanical structure. The vertical distance between the edge 26 of the shadow mask beam 19 and the covering surface 22 may typically be some hundred nanometers to some micrometers. The lateral motion for moving the shadow mask beam 19 from its initial position to the shading position or vice-versa may be obtained by an external actuator or also by a micromechanical actuator 38 described in further detail by way of example in FIGS. 4A to 4C below.

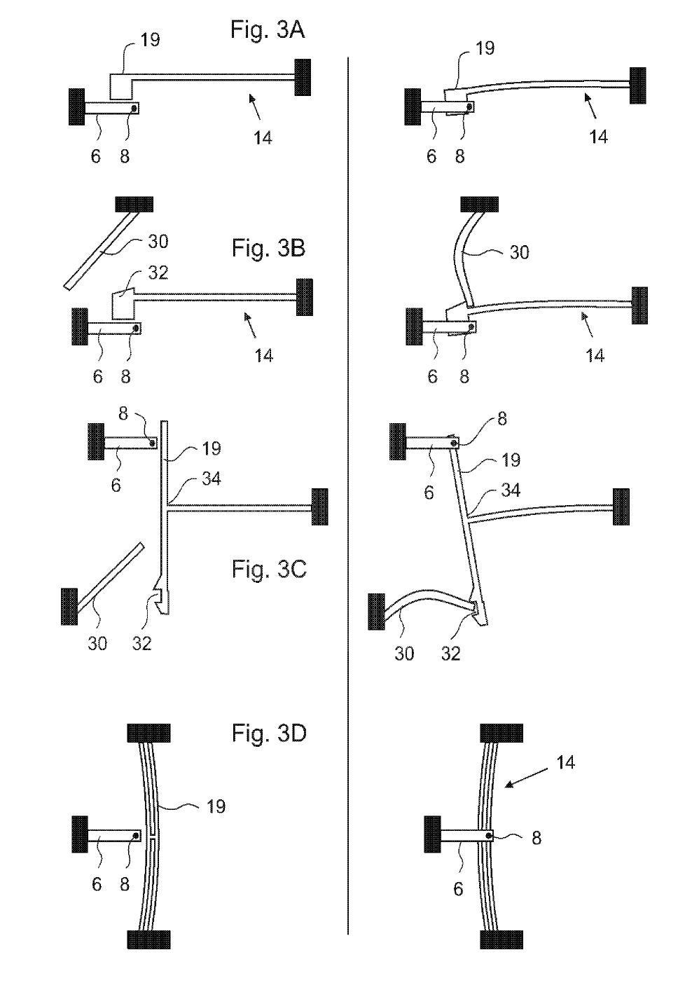

FIG. 3A shows the first embodiment of the micromechanical structure according to FIGS. 2A to 2C. Generally, in FIGS. 3A to 3D, only parts of the respective micromechanical systems are shown that are relevant to show the differences between the various embodiments. On the left-hand side, the shadow mask beam 19 is shown in its initial position, whereas on the right-hand side, the shadow mask beam 19 is shown in its shading position.

FIG. 3B shows a second embodiment of the micromechanical system. The shadow mask device 14 comprises a locking beam 30, which may be pivoted at its anchoring point around an axis being vertical to the plane of the figure, and then, eventually, establishes a snap-fit type connection with a locking element 32 of the shadow mask beam 19. In this way, in a locking state, the locking beam 30 is coupled to the locking element 32 in a way to fix the shadow mask beam 19 in its shading position. Thus, application of an external force to the shadow mask device 14 is not used in order to keep the shadow mask beam 19 in its shading position if the locking state has been achieved.

In a third embodiment of the micromechanical system (FIG. 3C), the shadow mask beam 19 is part of a lever 34.

In a fourth embodiment (FIG. 3D), the shadow mask beam 19 is in the form of a bistable latch. On the left-hand side of FIG. 3D, the bistable latch is shown in its initial position and on the right-hand side, the bistable latch is shown in its shading position.

FIGS. 4A to 4C disclose a fifth embodiment of the micromechanical system. In this embodiment, the shadow mask device 14 further comprises a micromechanical actuator 38. The micromechanical actuator 38 is of a thermal type. It comprises first and second beams which each are anchored to the frame structure 16. They are positioned to each other at an angle, preferably unequal to 180° in an initial state, that is, for example, at room temperature. A third beam is coupled to the first and second beams of the micromechanical actuator 38 protruding away in a lateral direction towards the locking beam 30. The first and second beams are arranged to each other in a V-type manner. When the micromechanical system is exposed to an elevated temperature, the difference in thermal response time between the frame structure 16 and the first and second beams of the micromechanical actuator 38 is exploited for thermal actuation. The frame structure has a large thermal capacity and therefore expands slowly when being exposed to the elevated temperature. The micromechanical actuator 38 has, due to its smaller mass, a smaller thermal capacity and therefore expands faster than the frame structure 16. This leads to an elongation of the third beam, which protrudes towards the locking beam, which finally pushes the locking beam into its locking state, where it is coupled to the locking element 32 of the shadow mask beam and therefore pushes the shadow mask beam 19 into its shading position.

The thermal actuation may also be accomplished by instead of using a rapid heating step, using a rapid cooling step which has the respective effect due to the different thermal capacities of the frame structure 16 and the micromechanical actuator 38. Actuation, in particular in the vertical direction, may also be accomplished by an additional layer on, for example, the shadow mask beam 19, which generates a defined stress making the shadow mask beam bend down.

When the micromechanical actuator 38 is no longer exposed to the elevated temperature, it moves back into its original position, as shown in FIG. 4C. The shadow mask beam 19, however, rests in its shading position and, therefore, now the deposition or treatment beam 20 may be generated in order to act on the covering area 24. The micromechanical actuator may, of course, also be of another type that is suitable and known to the person skilled in the art. It may, however, also be formed such that it directly acts on the shadow mask beam 19. It may, for example, also be an integrated electrostatic actuator, e.g. of a comb or bimorph form. It may also be designed such that it permanently acts on the shadow mask beam 19 while it is in its shading position.

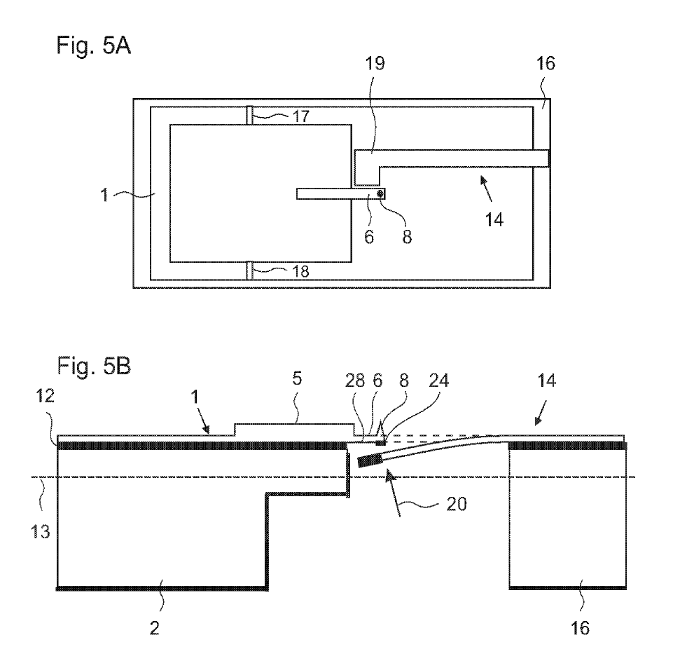

A sixth embodiment of the micromechanical system is distinguished by the shadow mask beam having a coplanar surface (FIGS. 5A and 5B) to the covering surface 22, which forms a vertical end of the shadow mask beam 19 facing towards the deposition or treatment beam 20, and the shadow mask beam being formed laterally to the micromechanical structure 1. In this embodiment, an actuator is used to move the shadow mask beam 19 to its shading position, which acts in the vertical direction on the shadow mask beam 19. Preferably, the actuator is then an external actuator. It may, however, also be of a suitable integrated type being formed from the wafer.

In all of the embodiments it is preferred that, prior to applying the deposition or treatment beam 20, the shadow mask beam 19 of the shadow mask device 14 is moved into the shading position. Then, the deposition or treatment beam is applied and results in the preferred embodiment in the deposition of the reflecting layer in the limited and small covering area 24 and forms a pad there. Preferably, then the shadow mask beam 19 is moved away from the shading position, for example back into its initial position. After that, the micromechanical structure is separated from the frame structure 16, that is, it is released from the frame structure 16, for example, by breaking the arms 17 and 18. Alternatively, the step of moving the shadow mask beam 19 away from the shading position may also be omitted prior to releasing the micromechanical structure 1 from the frame 16.

It will be understood that the present invention has been described purely by way of example, and modifications of detail can be made within the scope of the invention.

Each feature disclosed in the description, and (where appropriate) the claims and drawings may be provided independently or in any appropriate combination.

That which is claimed is:

1. A micromechanical system comprising:
a micromechanical structure including a covering surface to be acted upon in a covering area;
a shadow mask device, the shadow mask device provided for shading part of the micromechanical structure from a deposition or treatment beam; and having at least one geometry which affects a shading area in respect to the covering surface and which is produced in the course of geometry processing steps being applied from a same side of the wafer as covering surface processing steps for creating the covering surface;
a single wafer including the micromechanical structure and the shadow mask device; and
wherein the shadow mask device including at least one geometry which affects a shading area in respect to the covering surface and is produced in the course of geometry processing steps applied from a same side of the wafer as covering surface processing steps for creating the covering surface.

2. The micromechanical system according to claim 1:
wherein the wafer further includes a buried oxide layer; and
wherein the micromechanical structure is formed on one side of the buried oxide layer and the shadow mask device being formed on the other side of the buried oxide layer and the buried oxide layer being removed in the area of the covering surface and the shadow mask device.

3. The micromechanical system according to claim 1, wherein the shadow mask device further includes a shadow mask beam being movable between an initial position and a shading position.

4. The micromechanical system according to claim 3 wherein the shadow mask device further includes a micromechanical actuator for moving the shadow mask beam.

5. The micromechanical system according to claim 3, wherein the shadow mask beam is part of a lever.

6. The micromechanical system according to claims 3, wherein the shadow mask device further includes a locking device with a locking element associated to the shadow mask beam and a locking beam formed and arranged such that, in a locking state, the locking beam is coupled to the locking element so as to fix the shadow mask beam in its shading position.

7. The micromechanical system according to claim 3, wherein the shadow mask beam is a bistable latch.

8. The micromechanical system according to claim 3, wherein the shadow mask beam further includes a coplanar surface with the covering surface, the covering surface forming a vertical end of the shadow mask beam facing toward the deposition or treatment beam, and the shadow mask beam formed laterally to the micromechanical structure.

9. A method for manufacturing a micromechanical system, the micromechanical system including a micromechanical structure and a shadow mask device, the shadow mask device provided for shading part of the micromechanical structure from a deposition or treatment beam, the method comprising:
producing the micromechanical structure and the shadow mask device from a single wafer;
creating, in the course of covering surface processing steps, a covering surface in the micromechanical structure to be acted upon in a covering area;
creating at least one geometry in the shadow mask device, the geometry affects a shading area with respect to the covering surface in the course of geometry processing steps applied from a same side of the wafer as covering surface processing steps for creating the covering surface.

10. The method according to claim 9, wherein the wafer further includes a buried oxide layer prior to manufacturing the micromechanical structure and the method further comprising:
forming the micromechanical structure on one side of the buried oxide layer;
forming the shadow mask device on the other side of the buried oxide layer; and
removing the buried oxide layer in the area of the covering surface and the shadow mask device.

11. A method for manufacturing a micromechanical structure from a micromechanical system, the micromechanical system including a shadow mask device, the shadow mask device provided for shading part of the micromechanical structure from a deposition or treatment beam, the method comprising:
producing the micromechanical structure and the shadow mask device from a single wafer:
creating, in the course of covering surface processing, a covering surface in the micromechanical structure to be acted upon in a covering area;
creating at least one geometry in the shadow mask device affecting a shading area with respect to the covering surface in the course of geometry processing steps applied from a same side of the wafer as the covering surface processing; and
applying the deposition or treatment beam.

12. The method according to claim 11 further comprising moving, prior to applying the deposition or treatment beam, a shadow mask beam of the shadow mask device, thereby affecting the shading area in respect to the covering surface in a given shading position.

13. The method according to claim 12 further comprising moving, after applying the deposition or treatment beam, the shadow mask beam away from a given shading position thereby separating the micromechanical structure from a frame structure holding the micromechanical structure and the shadow mask device.

14. The method according to claim 11, wherein the wafer includes a buried oxide layer; and
the method further comprises forming, prior to manufacturing the micromechanical structure, the micromechanical structure on one side of the buried oxide layer;
forming a shadow mask device on the other side of the buried oxide layer; and
removing the buried oxide layer in the area of the covering surface and the shadow mask device.
